(19) United States
(12) Patent Application Publication
(10) Pub. No.: US 2008/0042404 A1
(43) Pub. Date: Feb. 21, 2008

(54) Mobile equipment for transport and positioning of disabled people

(76) Inventors: Mariele Mariani, Pegognaga (IT); Guilio Messora, Gonzaga (IT)

Correspondence Address: PYLE & PIONTEK;ATTN: THOMAS R. VIGIL, 221 N LASALLE STREET , ROOM 2036, ROOM 2036, CHICAGO, IL, 60601, US

(21) Appl. No.: 11/827,850

(22) Filed: Jul. 13, 2007

(30) Foreign Application Priority Data
Jan. 13, 2005 (IT) MN2005 A000002

(51) Int. Cl. B60N 3/00; A61G 7/10

(52) U.S. Cl. 280/657

(57) ABSTRACT

The invention describes mobile equipment for transport and positioning of differently-abled people of the type comprising a frame (2) positioned on wheels (3), a support structure (5) secured to the frame (2) and constituted of a quadrilateral with parallel arms (50 and 51) that engage with a seat (6), a control panel (70) positioned on a technical column (7) secured to the frame 2 and assigned to move a linear actuator, which makes the arms (50 and 51) of the support structure (5) perform a rotation of circa 90°, making the said arms rotate from a vertical position to a horizontal one and a hydraulic micro-control unit suitable to manage a hydraulic system for the powering of the linear actuator. The mobile equipment comprises, furthermore, a locking system suitable to prevent any movement at the wheels (3) safety devices envisaged to inhibit the activation of the arm rotation movement if the frame locking system is not activated, in addition to the safety means (8) to prevent overturning. The mobile equipment envisages, likewise, a manual emergency pump (9) suitable to raise the seat (6) manually and an emergency stop element (74). The mobile equipment is conceived to operate from a closed position in which an operator moves the equipment by means of a push, with the disabled person sitting on the seat, to a descent position in which the seat support structure rotates, making the seat shift and descend, without the sitting surface rotating, until the said seat is positioned at a level lower with respect to the surface on which the frame is resting.

### TECHNICAL FIELD

The present invention relates to mobile equipment for transport and positioning of people with walking difficulties, particularly recommended for transporting and positioning a differently-abled person or one with motor difficulties, including therein temporary ones, on a different level to that of transportation.

### BACKGROUND ART

As it is known, there are people with motor difficulties to differing degrees due to diverse pathologies that are either permanent or transitory, which means the operators deputed to handle these people are subjected to frequent, particularly tiring, operations in order to lift and move the person and bring them to the desired position.

The people that need to be moved are generally scarcely or not at all collaborative which means it becomes extremely tiring for the personnel employed to help these people, who carry out these operations, several times, over the space of the day. In fact, over the course of the day, the people require assistance on several occasions and the effort these operators have to make, to assist and aid these people in difficulty, during the diverse manoeuvres, are truly enormous.

To assist staff, at present, there exist machines on the market that carry out some or part of the operations necessary for moving people who are unable to walk. The machines generally used are lifts of various types: with straps or with harnesses, etc. These lifts, while performing their functions, have brought to light certain drawbacks.

A first drawback derives from the fact that, the person, during the transfer, finds themself in a scarcely comfortable position and, sometimes, in a freely swinging condition which creates notable discomfort. In particular, the operator has to employ physical effort to transfer and move the person, further to the fact that some of the lifting movements are still realised manually and this series of operations is, in the long run, tiring.

To reduce the effort or simply to succeed in moving these people in difficulty, very often, several operator intervene with considerable costs in terms of personnel who could be otherwise utilised.

Furthermore, some pathologies and disabilities do not allow the use of harnesses, which means the differently-abled people are handled with straps that, sometimes, are left on but can become annoying over time.

In addition to what has been illustrated so far, there exists nowadays a law that stipulates that the operators, subjected to substantial strains that are motor in character, are provided with mechanical aids to eliminate or at least considerably reduce the effort.

At present, in the different typologies of care and/or rehabilitation, it is now a consolidated fact that water is an ideal element in which to practise numerous activities to improve people's health and well-being in any period of their life. Nowadays, not everyone has easy access to water. In fact, for instance, differently-abled people (for whom water would be an ideal environment, given that it allows such remarkable freedom and facility of movement that their bodies feel “less different” from other people's) unfortunately encounter many, sometimes impassable, difficulties entering water, not only in a swimming pool, but even simply a bath. This situation is often a suffering experience for differently-abled people, often humiliating and so much so that, more often than not, they find themselves forced to give up.

In fact, in many swimming pools there is not always pre-installed equipment present to allow the differently-abled people to descend into water, and when present, these structures are positioned, however, in fixed points which means the people in difficulty must have the means to approach and reach the lift and, besides, access to the water with the lift is only available where the water is deepest, a situation that can create further discomfort and difficulties.

### DISCLOSURE OF INVENTION

The aim of the present invention is to resolve the problems of the commonly known technique overcoming the aforesaid drawbacks by means of mobile equipment for transport and positioning of differently-abled people, able to render it possible for one operator to move a person who is not in the condition to walk, the said person being differently-abled or in temporary difficulty, and to position them on a different, generally lower, level to that of transportation.

A second aim of the present invention is to realise mobile equipment for transport and positioning of differently-abled people able to allow the transportation of the disabled person from the swimming pool changing rooms or even from the exterior of the structure to the edge of the swimming pool and, contemporaneously, the descent into the water, in a gentle, simple and safe way, with facility and rapidity of execution.

A still further aim of the present invention is to realise mobile equipment for transport and positioning of differently-abled people able to obtain greater flexibility of use, notable safety and stability and, above all, comfort for the person transported.

A still further aim of the present invention is to realise mobile equipment for transport and positioning of differently-abled people which envisages, in its functional scope, the elimination of all effort by the operator.

A further but not final aim of the present invention is to realise mobile equipment for transport and positioning of differently-abled people able to feature great facility of use, which is simple to manufacture and works well and allows easy and quick maintenance.

These aims and others besides, which will better emerge over the course of the present description, are essentially achieved by mobile equipment for transport and positioning of differently-abled people, in accordance with the claims that follow.

Other characteristics and advantages will better emerge from the detailed description that follows of mobile equipment for transport and positioning of differently-abled people, in accordance with the present invention, provided below in the form of a non-limiting example, with reference to the accompanying drawings, in which:

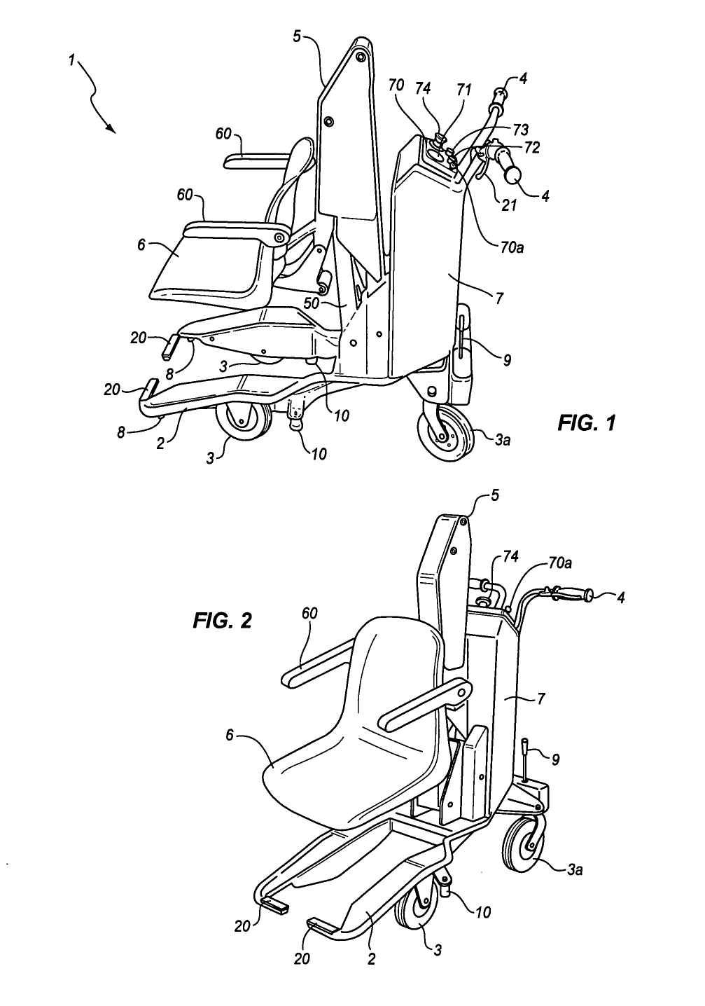

FIG. 1 shows, in a schematic view and a side view, the mobile equipment for transport and positioning of differently-abled people in question in the present invention;

FIG. 2 shows, in a schematic view and a perspective view, the mobile equipment shown in FIG. 1 in its closed position;

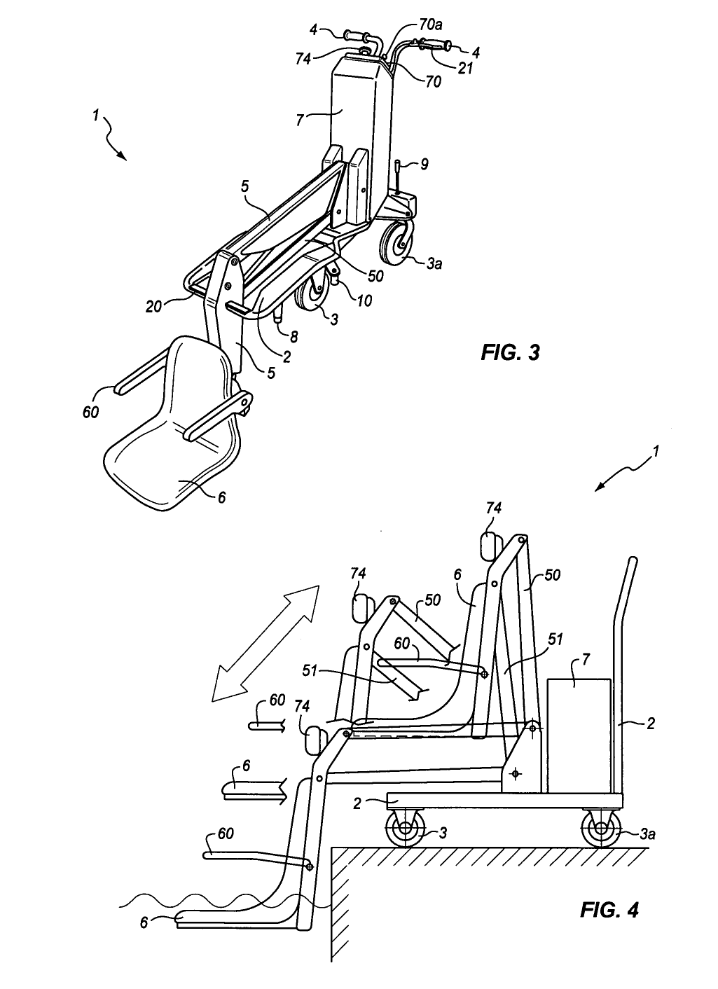

FIG. 3 shows, in a schematic way and a perspective view, the mobile equipment shown in FIG. 1 in its fully descended position;

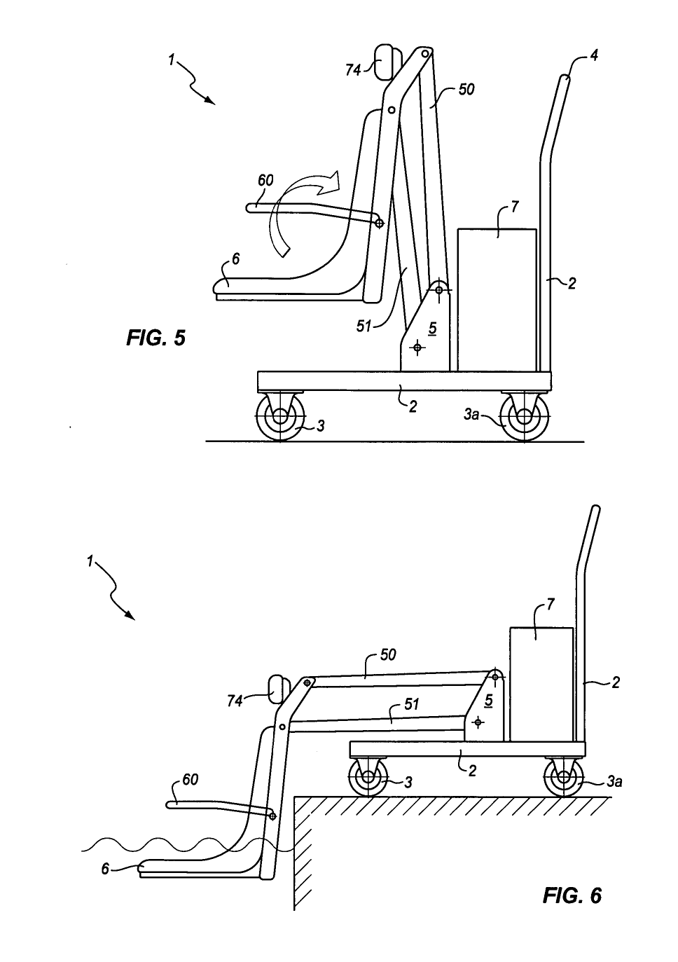

FIG. 4 shows, in a very schematic way and a side view, the mobile equipment in question in the initial and final moving positions;

FIG. 5 shows, in a very schematic way and a side view, the mobile equipment in question in the closed position;

FIG. 6 shows, in a very schematic way and a side view, the mobile equipment in question in the descent position;

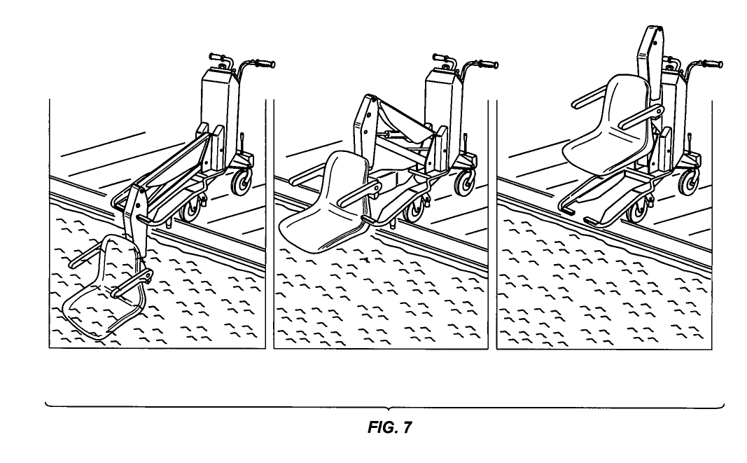

FIG. 7 shows, in a perspective view, the mobile equipment according to the present invention during the sequence of movement from the descent position to the closed position.

With reference to the figures mentioned and in particular FIG. 1, number 1 is the mobile equipment, as a whole, for transport and positioning of differently-abled people, in accordance with the present invention.

The mobile equipment for transport and positioning of differently-abled people 1 is essentially composed of a frame 2 positioned on wheels 3, of which at least one 3a is pirouetting to determine the said frame's direction. The movement of the equipment 1 comes about through a manual push by an accompanying person by means of a special handle 4 positioned in the rear part of the frame.

The mobile equipment 1 comprises a support structure 5 secured irremovably to the frame 2 constituted of a quadrilateral with parallel arms (50 and 51) that engage with a seat 6 as shown in FIG. 1. In greater detail, the support structure 5 is designed to move from a closed position in which the arms (50 and 51) are arranged, essentially, in a vertical way to a descent position in which the arms (50 and 51) are arranged horizontally and the seat is positioned at a level lower with respect to the ground on which the frame 2 is resting, as shown in FIGS. 2 and 3.

Furthermore, the frame 2 features a locking system 21 that comprises on-board brakes or a parking system suitable to prevent any movement at the wheels. In particular, the wheel locking system is constituted of a mechanical brake that acts on the hub on the front wheels and not on the rubber to avoid the risk that, for instance, with damp ground, the grip of the rubber may be reduced. Furthermore, the locking system, once activated, sends the clearance signal to the micro-control unit so that the support structure can move.

In accordance with the present embodiment, the mobile equipment is equipped with a control panel 70 positioned on a technical column 7, shown in FIGS. 3 and 5, secured to the frame 2 and envisaged to move a linear actuator, located on the support structure, which makes the arms (50 and 51) perform a rotation of circa 90°, making the arms rotate from the vertical position to the horizontal one.

In greater detail, the powering of the linear actuator is realised by means of electric energy transformed into hydraulic energy by a hydraulic micro-control unit in which the hydraulic system is fitted with safety valves and valves which limit the capacity for movement in order to prevent incorrect use of the equipment. The hydraulic micro-control unit is positioned on the technical column 7.

According to the present invention, during the movement of the arms, the seat always remains parallel to the ground with the sitting surface perfectly horizontal and when the arms are in the horizontal position, the seat is at a lower level with respect to the ground and is immersed in the water as shown in FIGS. 4 and 6.

Furthermore, the movement of the seat can be interrupted at any point during the descent route or when returning up and the seat's movement speed is constant.

According to the present embodiment, the control panel 70 comprises a key 70a to switch on the equipment, a panel 71 that indicates the power supply battery charge level, a button 72 that starts the descent of the arms and a button 73 that starts the arms returning up and an emergency stop element 74 that stops the arms moving in the exact position in which they are at the moment of intervention.

Furthermore, the mobile equipment envisages safety devices such as the inhibition of the activation of the arm rotation movement if the frame locking or parking system is not activated, in fact, if the equipment does not have the brake applied to the wheels it is not possible to activate the arms for the descent.

Furthermore, the mobile equipment 1 is fitted with safety means 8 to prevent overturning in compliance with standard EN280 relating to “aerial platforms for lifting people”. In fact, while the arms descend, two feet 8, each of which is constituted of a steel structure with a rubber covering, rest on the ground to prevent the said equipment turning over.

In addition to what has been illustrated so far, the mobile equipment 1 is fitted with a manual emergency pump 9 which is used in the event that the electric system that makes the seat return up does not work. Finally, the mobile equipment 1 is fitted with rubber pads 10 between the front and rear wheels which prevent the equipment entering the water in the event of an incorrect manoeuvre.

In accordance with the present invention, the seat of the equipment features a couple of arm rests 60 and the frame 2 features a couple of rests 20 for the feet.

The mobile equipment for transport and positioning differently-abled people 1 is conceived to operate from a closed position where an operator moves the equipment by means of a push, with the disabled person sitting on the seat, to a descent position in which the seat support structure rotates, making the seat shift and descend, without the sitting surface rotating, until the said seat is immersed in the water.

After this predominantly structural description, there will now follow a description of the functioning of the invention in question.

When an accompanying person wishes to immerse a person who is unable to walk in a swimming pool they simply have to sit the differently-abled person on the seat 6 with the support structure 5 in the closed position and then, grasping the handle 4, exert a pushing action against the frame 2, which will move by shifting to the edge of the pool.

Once the differently-abled person has reached an area in proximity to the descent into the water, the wheels on the frame are locked by the on-board brakes and the feet 8 will descend, the accompanying person, by means of the descent button 72 on the control panel 70, will send an order to the micro-control unit that will move the linear actuator, which will perform the rotation of the support structure thereby moving the seat, which will shift and descend until immersed in the water as shown in FIG. 7.

At this point, the differently-abled person, sitting on the seat, is already in the water and is able to carry out the activities envisaged.

When the person has finished their stay in the pool they will simply have to sit down on the seat again and the accompanying person, by activating the return button 73, will activate the actuator, which will make the arms move in reverse, bringing the seat to back to the initial closed position. In particular, once the person is in the water, the seat can be made to return up, bringing it back into the closed position for subsequent utilization.

The present invention thereby achieves the aims set.

In fact, the mobile equipment for transport and positioning differently-abled people in question offers a single operator the possibility to move a person who is unable to walk since they are differently-abled or in temporary difficulty and to position them on a different level, in general a lower one, with respect to that of transportation.

Advantageously, the mobile equipment according to the present invention enables the transport of disabled people from the swimming pool changing rooms to the edge of the pool and, contemporaneously, the descent into the water in a gentle, simple and safe way, with facility and rapidity of execution. In addition, when the disabled person arrives at the swimming pool, when descending from the means of transport, they can sit down directly onto the seat of the equipment, without having to use a wheelchair.

Furthermore, if the disabled person has to leave the water quickly, if they are suddenly taken ill, for instance, with the equipment in question it is possible to do so in a very short space of time, a situation that is impossible with structures according to the commonly known technique. In particular, even though there is a lifeguard present, in the event that the disabled person has problems or difficulty in the water, the mobile equipment can simply be brought to the edge of the pool at the point nearest the person without having to move them in the water to bring them to a fixed lift.

Furthermore, swimming pool lifts according to the commonly known technique are anchored to the edge of the pool which means access to the point of descent into the water is obligatory and, as a consequence, any inconvenience or obstruction in proximity to the lift prevents the disabled person gaining access to the water while with the mobile equipment according to the present invention access to the water in the pool is possible in any point. In addition, the installation of lifts of the commonly known type requires feasibility studies and structural interventions on the edge of the swimming pool in addition to building work for the anchorage of the structure of the said lift since the lifts used at present require everything to be secured to fixed structures.

A further advantage of the mobile equipment derives from the fact that it guarantees good flexibility of use, notable safety and stability and, above all, comfort for the person transported.

In addition to what has been stated so far, the mobile equipment in question envisages, within its functional scope, the elimination of all effort by the operator and the drastic reduction in many of the manual operations effected with lifts according to the commonly known technique. Furthermore, the mobile equipment ensures movement of the differently-abled person in simple and limited sequences that are homogeneous and comfortable.

In particular, the mobile equipment proves practical, extremely easy to handle and also reliable and safe thanks to the presence of the safety devices present.

A further but not final advantage is due to the fact that the mobile equipment features great facility of use, is simple to manufacture and works well, and does not require any particular maintenance. Furthermore the mobile equipment according to the present invention features a notable structural simplicity and this allows construction costs to be limited.

Naturally, numerous modifications and variants could be applied to the present invention, without falling outside the scope of the invention defining it.

1) Mobile equipment for transport and positioning of differently-abled people characterised by the fact that the said equipment comprises:
a frame (2) positioned on wheels (3) of which at least one (3a) is pirouetting to determine the said frame's direction;
a support structure (5) secured irremovably to the frame (2) constituted of a quadrilateral with parallel arms (50 and 51) that engage with a seat (6);
a control panel (70) positioned on a technical column (7), secured to the frame 2 and envisaged to move a linear actuator, which makes the arms (50 and 51) of the support structure (5) perform a rotation of about 90°, making the arms rotate from a vertical position to a horizontal one;
a locking system (21) that comprises on-board brakes or a parking system suitable to prevent any movement at the wheels (3) on the frame (2);
a hydraulic micro-control unit suitable to manage the hydraulic system, fitted with a safety valves and valves which limit the capacity for movement for the powering of the linear actuator which is realised by means of electric power transformed into hydraulic power;
safety devices envisaged for the inhibition of the activation of the arm rotation movement if the frame (2) locking or parking system is not activated;
safety means (8) to prevent overturning;
emergency manual pump (9) suitable for raising the seat (6) manually;
an emergency stop element (74);
power supply batteries;
the said mobile equipment being conceived to operate from a closed position in which an operator moves the equipment by means of a push, with the disabled person sitting on the seat, to a descent position in which the seat support structure rotates, making the seat shift and descend, without the sitting surface rotating, until the said seat is positioned at a level lower with respect to the surface on which the frame is resting.

2) Mobile equipment for transport and positioning of differently-abled people according to claim 1 characterised by the fact that the movement of the said equipment comes about through a manual push by means of a special handle (4) positioned in the rear part of the frame (2).

3) Mobile equipment for transport and positioning of differently-abled people according to claim 1 characterised by the fact that the support structure (5) is configured to move from a closed position in which the arms (50 and 51) are arranged, essentially, in a vertical way, to a descent position in which the arms (50 and 51) are arranged horizontally and the seat is positioned at a lower level with respect to the ground on which the frame (2) is resting.

4) Mobile equipment for transport and positioning of differently-abled people according to claim 1 characterised by the fact the said wheel locking system is constituted of a mechanical brake that acts on the hub of the front wheels and not on the rubber.

5) Mobile equipment for transport and positioning of differently-abled people according to claim 1, characterised by the fact the said micro control unit is located in the technical column (7).

6) Mobile equipment for transport and positioning of differently-abled people according to claim 1, characterised by the fact that, during the movement of the arms, the seat always remains parallel to the ground with the sitting surface perfectly horizontal and when the arms are in the horizontal position the seat is at a lower level with respect to the ground.

7) Mobile equipment for transport and positioning of differently-abled people according to claim 1 characterised by the fact that the said control panel (70) comprises a key (70a) to switch on the equipment, a panel (71) that indicates the power supply battery charge level, a button (72) that starts the descent of the arms and a button (73) that starts the arms returning up and an emergency stop element (74) that stops the arms moving in the exact position in which they are at the moment of intervention.

8) Mobile equipment for transport and positioning of differently-abled people according to claim 1, characterised by the fact that the said safety means (8) to prevent overturning comprises two feet (8), each of which is constituted of a steel structure with a rubber covering and rest on the ground to prevent the said equipment turning over.

9) Mobile equipment for transport and positioning of differently-abled people according to claim 1, characterised by the fact that the said equipment comprises rubber pads (10), positioned between the front and rear wheels which prevent the equipment entering the water in the event of an incorrect manoeuvre.

10) Mobile equipment for transport and positioning of differently-abled people according to claim 1, characterised by the fact the said seat features a couple of armrests (60).

11) Mobile equipment for transport and positioning of differently-abled people according to claim 1, characterised by the fact the frame (2) is fitted with a couple of rests (20) for the feet.
